(19) United States
(12) Patent Application Publication
(10) Pub. No.: US 2006/0256709 A1
(43) Pub. Date: Nov. 16, 2006

(54) Method and apparatus for identifying mobile stations in a wireless communication network

(76) Inventor: Yunsong Yang, San Diego, CA (US)

Correspondence Address: Yunsong Yang, 4667 Torrey Circle, #G204, San Diego, CA, 92130, US

(21) Appl. No.: 11/431,306

(22) Filed: May 9, 2006

Related U.S. Application Data
(60) Provisional application No. 60/679,240, filed on May 10, 2005.

(51) Int. Cl. H04J 11/00

(52) U.S. Cl. 370/206

(57) ABSTRACT

The present invention provides methods and apparatus for identifying the target mobile stations for data transmission in a wireless communication network. Two preambles with the first preamble being transmitted on one branch of the in-phase and quadrature signal and the second preamble, if transmitted, being transmitted on the other branch of the in-phase and quadrature signal, and the choice of which branch the first preamble is transmitted on collectively determines the MACIndex, which is the identity of the target mobile station in the system. The design of multiple MACIndex Extension Levels minimizes the performance impact due to the increased MACIndex numbers. Methods for detecting the secondary preamble by performing hypothesis testing are provided. An enhanced Multi-User Packet format that supports both the legacy MACIndex and the new expanded MACIndex in the same packet is described.

### CROSS-REFERENCE TO RELATED APPLICATIONS

This application claims the benefit of U.S. Provisional Application Ser. Nos. 60/679,240, entitled “METHOD AND APPARATUS FOR DATA TRANSMISSION IN A WIRELESS COMMUNICATION NETWORK” and filed on May 10, 2005, and 60/684,226, entitled “METHOD AND APPARATUS FOR IDENTIFYING MOBILE STATIONS IN A WIRELESS COMMUNICATION NETWORK” and filed on Mat 25, 2005, which are incorporated herein by reference in their entireties for all purposes.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

1. Field of the Invention

The present invention generally relates to wireless communication networks. More particularly, the present invention relates to a novel and improved method of identifying the target mobile stations for the transmission of data packet in a wireless communication system.

2. Description of the Related Art

Wireless communication systems provide voice or data services to a plurality of wireless or mobile stations situated within a geographic region by dividing the region into a number of cells, conceptually represented by a hexagon in a honeycomb pattern. In practice, however, each cell may have an irregular shape, depending on various factors including the terrain surrounding the cell and traffic density. Each cell may be further divided into two or more sectors. Each cell contains system communication equipment such as a base station that transmits communication signals to the mobile stations on the forward link and receives communication signals from the mobile stations on the reverse link.

One particular wireless communication system designed for high speed packet data services is 1xEV-DO, which is also known as High Date Rate (HDR) or High Rate Packet Data (HRPD) system. 1xEV-DO has been standardized as C.S0024 in the international standard group Third Generation Project Partnership Two (3GPP2) and has been published as IS-856 Revision 0 and Revision A standards in the United States. In 1xEV-DO system, a mobile station, which is also known as the access terminal or AT, determines and reports the data rate that can be supported on the forward link in the Data Rate Control (DRC) message. The base station, which is also known as the access network or AN, selects one Physical Layer packet for forward link transmission at a particular time slot, based on the DRC messages received from various mobile stations. The Physical Layer packet may be given more than one time slot for transmission. In this case, the transmit slots of a Physical Layer packet are separated by three intervening slots, during which the slots of other Physical Layer packets can be transmitted. If a positive acknowledgement (ACK) is received on the reverse link ACK Channel before all of the allocated slots have been transmitted, the remaining un-transmitted slots will not be transmitted and the next allocated slot may be used for the first slot of a new Physical Layer packet transmission. This technique is known as Hybrid Automatic Repeat Request (HARQ).

In a 1xEV-DO system, in order to identify the target mobile station of the forward data packet, the base station transmits a preamble on the I-branch, which is the in-phase branch of the complex signal, before the data packet. Meanwhile, no signals are transmitted on the Q-branch, which is the quadrature branch of the complex signal. The preamble contains the repetition of 32-chip bi-orthogonal sequence as in IS-856 Revision 0 standard, or repetition of 64-chip bi-orthogonal sequence as in IS-856 Revision A standard. The 32-chip bi-orthogonal sequence is defined in terms of the 32-ary Walsh functions and their bit-by-bit complements by

$$\begin{matrix}{W}_{i / 2}^{32} for i = 0 , 2 , … , 62 & ( 1 ) \\ \overline{{W}_{( i - 1 ) / 2}^{32}} for i = 1 , 3 , … , 63 & ( 2 )\end{matrix}$$

where i=0, . . . , 63 is the MACIndex value and \overline{Wᵢ³²} is the bit-by-bit complement of the 32-chip Walsh function of order i. The MACIndex is a number, which is assigned by the base station for identifying a mobile station in the system. Some MACIndex values are used as common values to all mobile stations for the purpose to identify the Control Channel, Broadcast, or Multi-User Packet transmissions. The 64-chip bi-orthogonal sequence is defined in terms of the 64-ary Walsh functions and their bit-by-bit complements by

$$\begin{matrix}{W}_{i / 2}^{64} for i = 0 , 2 , … , 126 & ( 3 ) \\ \overline{{W}_{( i - 1 ) / 2}^{64}} for i = 1 , 3 , … , 127 & ( 4 )\end{matrix}$$

where i=0, 1, . . . , 127 is the MACIndex value and \overline{Wᵢ⁶⁴} is the bit-by-bit complement of the 64-chip Walsh function of order i. The repetition of 32-chip bi-orthogonal sequence is a subset of the 64-chip bi-orthogonal sequence, as Walsh functions can be generated by means of the following recursive procedure:

$${W}^{1} = + 1 , \\ {W}^{2} = \begin{matrix}+ 1 & + 1 \\ + 1 & - 1\end{matrix} , \\ {W}^{4} = \begin{matrix}+ 1 & + 1 & + 1 & + 1 \\ + 1 & - 1 & + 1 & - 1 \\ + 1 & + 1 & - 1 & - 1 \\ + 1 & - 1 & - 1 & + 1\end{matrix} , \\ {W}^{2 N} = \begin{matrix}{W}^{N} & {W}^{N} \\ {W}^{N} & \overline{{W}^{N}}\end{matrix} , \qquad ( 5 )$$

where N is a power of 2 and \overline{W^{N}} denotes the bit-by-bit complement of W^{N}. Therefore, IS-856 Revision A standard doubles the MACIndex numbers while supporting the legacy mobile stations that comply with the IS-856 Revision 0 standard in an IS-856 Revision A network. The length of the preamble is variable from 64 chips to 1024 chips, depending on the data packet format.

To support real-time or near real-time services such as Voice over Internet Protocol (VoIP), the IS-856 Revision A standard specifies a Multi-User Packet (MUP), which is a data packet consists of one or more Security Layer packets addressed to different mobile stations. The base station transmits a preamble with a common MACIndex value for the Multi-User Packet so that all mobile stations that support the Multi-User Packet will pay attention to it. The individual MACIndex values for the target mobile stations of the Multi-User Packet are embedded in the MAC Header in the MAC Layer packet. Therefore, a mobile station needs to decode the Multi-User Packet correctly before it can determine whether it is one of the target mobile stations.

Maximally 128 MACIndex values can be supported in an IS-856 Revision A system.

As 1xEV-DO evolves to provide broadband services, particularly with a multi-carrier based solution, the system may need to support more than 128 mobile stations for each sector. The industry is currently investigating methods that can increase the MACIndex numbers while maintaining backward compatibility in such a way that the legacy mobile stations can be supported in the same upgraded system.

### SUMMARY OF THE INVENTION

Novel and improved methods and apparatus for increasing the number of MACIndex, which is used for identifying mobile stations in a wireless communication system, are present. In one aspect, a method for transmitting data packets in a wireless communication network is present, the method comprising: generating a first preamble, wherein the first preamble carries the first portion of the target mobile station identity information; generating a second preamble, wherein the second preamble carries the second portion of the target mobile station identity information; applying the first preamble with the first transmit power on one branch of the in-phase and quadrature signal while applying the second preamble with the second transmit power on the other branch of the in-phase and quadrature signal, wherein which branch the first preamble is transmitted on depends on the third portion of the target mobile station identity information; transmitting the in-phase and quadrature signal of the first preamble and the second preamble before the data packet.

In another aspect, an apparatus for generating the first preamble and the second preamble within a wireless communication system is present, wherein the first preamble and the second preamble and on which branch of the in-phase and quadrature signal the first preamble is transmitted on collectively identifies the target mobile station, the apparatus comprising: mapping elements configured to receive a sequence of bits and output a sequence of symbols +1, −1 accordingly; a bi-orthogonal sequence specified in terms of the 64-ary Walsh functions and their bit-by-bit complements; covering elements configured to spread the outputs of the mapping elements with different bi-orthogonal sequences; repetition elements configured to repeat the outputs of the covering elements according to the preamble length; gain elements configured to apply variable gains on the outputs of the repetition elements; a switching element configured to apply the output of the first gain element onto one branch of the in-phase and quadrature signal while applying the output of the second gain element onto the other branch of the in-phase and quadrature signal.

It is an object of the present invention to minimize the performance impact due to the power sharing between the first preamble and the second preamble. In one aspect, a method for detecting the second preamble by performing hypothesis testing of the received second preamble signal against all hypothesized second preamble signals by the mobile receiver is present. In another aspect, a method for detecting the second preamble by performing least square estimate of the received second preamble signal against all hypothesized second preamble signals by the mobile receiver is present. In yet another aspect, a method of defining multiple MACIndex Extension Levels (MEL) is present, wherein each MACIndex Extension Levels supports different number of MACIndex values. Accordingly, the second preamble contains from no signal, to one of two possible signals, to one of four possible signals, to one of eight possible signals, and so on, depending on the MACIndex Extension Level that the base station is using. The base station, by informing the mobile stations about the MACIndex Extension Level that it is using in signaling messages, allows each mobile station to determine whether the second preamble is transmitted with non-zero power, and if transmitted with non-zero power, what the hypothesized second preamble signals are therefore need to be tested in performing the hypothesis testing against the receiving second preamble signal.

In another aspect, an apparatus for performing the hypothesis testing is present, the apparatus comprising: a memory configured to provide the hypothesized bi-orthogonal sequences based on the current MACIndex Extension Level; despreading elements configured to despread the received second preamble signal with the hypothesized bi-orthogonal sequences from the memory; summing elements configured to sum up the outputs of the despreading elements over the preamble length; a selecting element configured to select the hypothesis that results in the largest summed value from the outputs of the summing elements; a comparing element configured to compare the output of the selecting element with the anticipated second preamble.

In yet another aspect, another apparatus for performing the hypothesis testing is present, the apparatus comprising: a memory configured to provide the hypothesized bi-orthogonal sequences based on the current MACIndex Extension Level; multiplying elements configured to scale the hypothesized bi-orthogonal sequences from the memory with a gain factor; subtracting elements configured to subtract the received second preamble signal from the outputs of the multiplying elements; squaring elements configured to produce the squares of the outputs of subtracting elements; summing elements configured to sum up the outputs of the squaring elements over the preamble length; a selecting element configured to select the hypothesis that results in the smallest summed value from the outputs of the summing elements; a comparing element configured to compare the output of the selecting element with the anticipated second preamble.

It is another object of the present invention to support the Multi-User MAC Layer Packet format with the increased MACIndex number. In one aspect, a method of enhancing the Multi-User MAC Layer Packet is present, the method comprising: inserting the MACHeaderDelimiter field, the PacketInfo Trailers that contains the second portion and third portion of the mobile station identity information, if needed, and PacketInfo Trailer Indicators in the existing Multi-User MAC Layer Packet structure.

### BRIEF DESCRIPTION OF THE DRAWINGS

FIG. 1 is a diagram of forward link time slot structure in a 1xEV-DO system;

FIG. 2 is a diagram showing the preamble structure in the existing 1xEV-DO system;

FIG. 3 is a diagram showing the format of Multi-User MAC Layer Packet in the existing 1xEV-DO system;

FIG. 4 is a diagram of the exemplary channel structure of the Primary Preamble and Secondary Preamble according to the first embodiment of the present invention;

FIG. 5A is an exemplary diagram showing the base station procedures for transmitting the Primary Preamble and the Secondary Preamble according to the first embodiment of the present invention;

FIG. 5B is an exemplary diagram showing the base station procedures for determining the Primary Preamble Gain and Secondary Preamble Gain according to the first embodiment of the present invention;

FIG. 6A is an exemplary diagram showing the mobile station procedures for detecting the Primary Preamble, the Secondary Preamble, and the data packet according to the first embodiment of the present invention;

FIG. 6B is an exemplary diagram showing the mobile station procedures for determining whether the Secondary Preamble is expected according to the first embodiment of the present invention;

FIG. 6C is an exemplary diagram showing the mobile station procedures for detecting the Primary Preamble according to the first embodiment of the present invention;

FIG. 7A is an exemplary diagram showing a method and apparatus for performing the hypothesis testing on the Secondary Preamble according to the first embodiment of the present invention;

FIG. 7B is an exemplary diagram showing an alternative method and apparatus for performing the hypothesis testing on the Secondary Preamble according to the first embodiment of the present invention;

FIG. 8 is a diagram of the exemplary channel structure of the Primary Preamble and Secondary Preamble according to the second embodiment of the present invention;

FIG. 9A is an exemplary diagram showing the base station procedures for transmitting the Primary Preamble and the Secondary Preamble according to the second embodiment of the present invention;

FIG. 9B is an exemplary diagram showing the base station procedures for determining the Primary Preamble Gain and Secondary Preamble Gain according to the second embodiment of the present invention;

FIG. 10A is an exemplary diagram showing the mobile station procedures for detecting the Primary Preamble, the Secondary Preamble, and the data packet according to the second embodiment of the present invention;

FIG. 10B is an exemplary diagram showing the mobile station procedures for detecting the Primary Preamble according to the second embodiment of the present invention; and

FIG. 11 is an exemplary diagram showing the enhanced Multi-User Packet format according to the present invention.

### DETAILED DESCRIPTION OF THE INVENTION

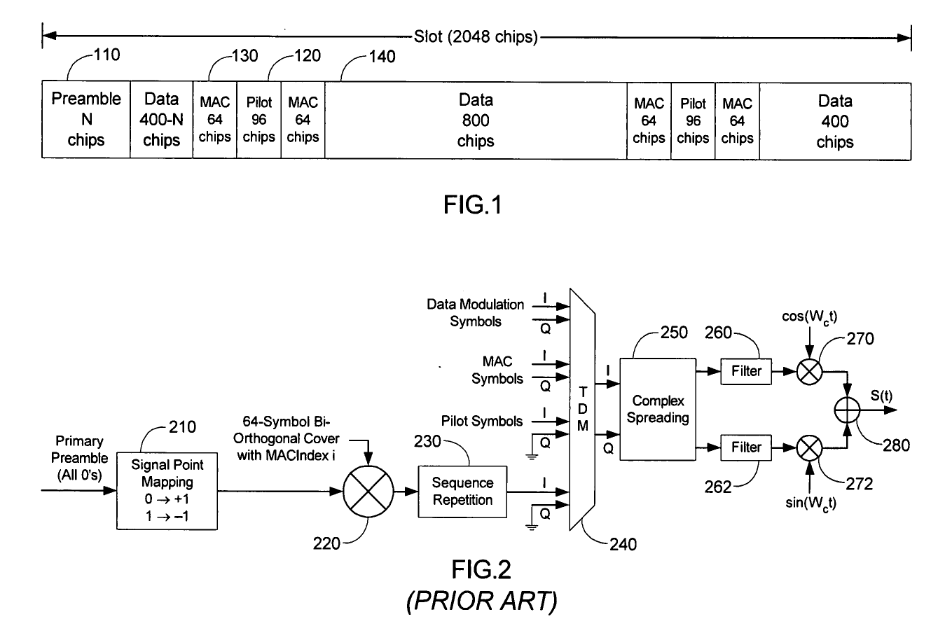

FIG. 1 shows the time slot structure in 1xEV-DO system. Referring to FIG. 1, within each time slot, preamble 110, which is transmitted for the first slot of each data packet, Pilot 120 symbols, Media Access Control (MAC) 130 symbols, and Data 140 symbols are time-division multiplexed and are transmitted at the same power level.

FIG. 2 shows the preamble structure in the existing 1xEV-DO system. Referring to FIG. 2, the preamble consists of all-“0” symbols. Signal Point Mapping 210 maps the all-“0” symbols into “+1” sequences. The sequence is then spread by multiplier 220 with a 64-chip bi-orthogonal cover. Sequence repeater 230 produces the repetition of the bi-orthogonal covered sequences with a repetition factor of 1 to 16, according to the preamble length. The preamble signal is then applied to I-branch while Q-branch is gated off. It is then time-division multiplexed (TDM) by multiplexer 240 with the signals of Data 140 modulation symbols, Pilot 120 symbols, and MAC 130 symbols, as illustrated in FIG. 1. The time-division multiplexed signals are further spread by complex spreader 250, filtered by baseband filter 260, 262, and modulated onto the carrier frequency by modulator 270, 272 with the in-phase sinusoid cos(W_{c}t) and the quadrature sinusoid sin(W_{c}t) respectively. The modulated I-branch and Q-branch signals are summed up by summer 280 to produce the transmitted waveform S(t).

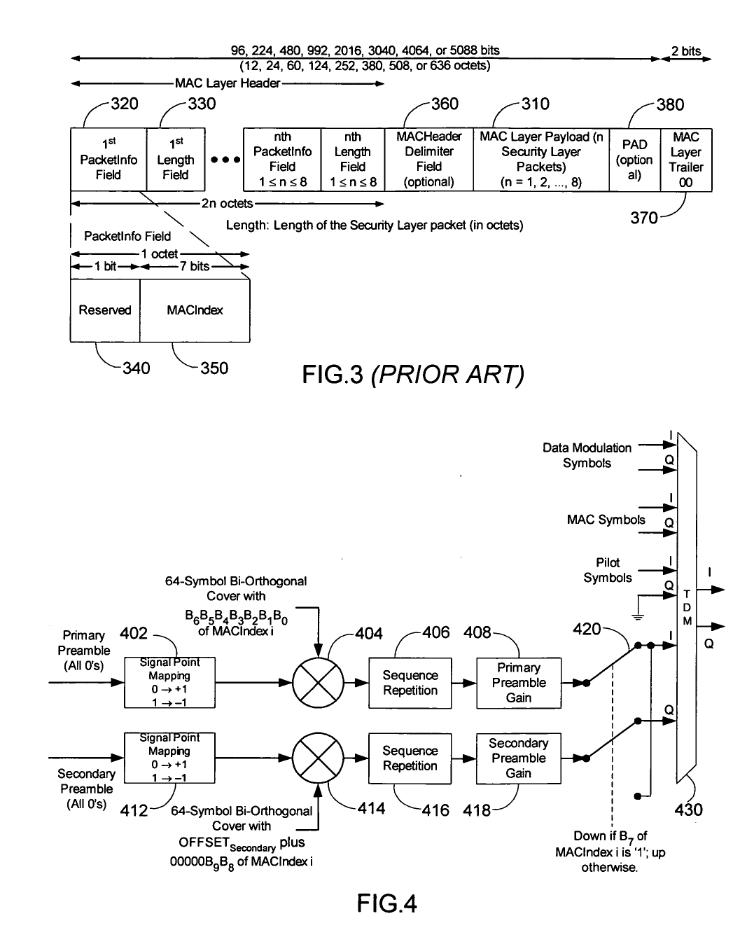

FIG. 3 shows the format of the Multi-User MAC Layer Packet in the existing 1xEV-DO system. Referring to FIG. 3, the Multi-User MAC Layer Packet consists of MAC Layer Payload 310 of n Security Layer packets, where n is an integer from one to eight. The MAC Layer header consists of n PacketInfo 320 fields and n Length 330 fields. The nth PacketInfo 320 field contains a reserved bit 340 and seven bits of MACIndex 350 of the mobile station to which the nth security layer packet is addressed. The nth Length 330 field indicates the length, in octets, of the nth Security Layer packet in MAC Layer Payload 310. MACHeaderDelimiter 360 is included if the MAC Layer Packet size exceeds the sum of the length of the Security Layer Packets, MAC header, and MAC Trailer 370 by one or more octets. If included, MACHeaderDelimiter 360 is set to ‘0000000’. Pad 380 bits are included if the size of the MAC Layer Packet exceeds the sum of the lengths of the n Security Layer packets, MAC header, MACHeaderDelimiter 360 (if included), and MAC Trailer 370. If included, Pad 380 bits are all “0”. The preamble for a Multi-User Packet uses the common MACIndex values that are known to all mobile stations.

The present invention provides unique methods to increase the number of mobile station identities in a wireless communication network while maintaining backward compatibility with legacy system. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail.

For clarity, an exemplary system that can maximally support 1024 MACIndex values is described herein to illustrate the techniques in the present invention that increase the number of MACIndex values, which are represented by 10 bits B₉B₈B₇B₆B₅B₄B₃B₂B₁B₀.

FIG. 4 illustrated the channel structure of the Primary Preamble and the Secondary Preamble according to the first embodiment of the present invention. Referring to FIG. 4, the preamble consists of two parts, the Primary Preamble and the Secondary Preamble. The Primary Preamble sequence and the Secondary Preamble sequence consist of all-“0” symbols. Signal Point Mapping elements 402 and 412 map the all-“0” symbols into “+1” sequences. The output sequences are spread by multipliers 404 and 414 with a 64-chip bi-orthogonal cover. The 64-chip bi-orthogonal cover on the Primary Preamble is generated from the seven least significant bits B₆B₅B₄B₃B₂B₁B₀ of the MACIndex according to equations (3) and (4), where the order i is the value of B₆B₅B₄B₃B₂B₁B₀ of the MACIndex. The 64-chip bi-orthogonal cover on the Secondary Preamble is generated from the two most significant bits B₉B₈ of the MACIndex according to equations (3) and (4), where the order i is the value of the sum of OFFSET_{Secondary} and 00000B₉B₈. The OFFSET_{Secondary} is an even number known to both the base station and the mobile stations. The sum of OFFSET_{Secondary} and 00000B₉B₈ has a value less than 128 but cannot have the values of 0, 1, 64, or 65, as these values may cause the receiver to mistake the Secondary Preamble signal as Pilot 120 signal. In addition, if the MACIndex Extension Level allows the Secondary Preamble to be transmitted with non-zero power on the I-branch, the sum of OFFSET_{Secondary} and 00000B₉B₈ cannot have the same value as any MACIndex values that have already been assigned for a legacy mobile or for legacy Control Channel, Broadcast, or Multi-User Packet transmissions. Sequence repeaters 406 and 416 produce the repetition of the bi-orthogonal covered sequences with a repetition factor of 1 to 16, according to the preamble length. Then the Primary Preamble signal is scaled by Primary Preamble Gain element 408 and the Secondary Preamble signal is scaled by Secondary Preamble Gain element 418. The Primary Preamble Gain and the Secondary Preamble Gain maintain a constant total transmit power on the complex preamble signal. Double-pole double-throw switch 420 applies the Primary Preamble signal onto the I-branch and the Secondary Preamble signal onto the Q-branch if the bit B₇ of the MACIndex is “0”; or it applies the Primary Preamble signal onto the Q-branch and the Secondary Preamble signal onto the I-branch if the bit B₇ of the MACIndex is “1”. Thus the Primary Preamble and the Secondary Preamble are not transmitted on the same branch at the same time. The complex preamble signal is then time-division multiplexed (TDM) by multiplexer 430 with the complex signals of Data 140 modulation symbols, Pilot 120 symbols, and MAC 130 symbols, as illustrated in FIG. 1. The time-division multiplexed signals are further spread by complex spreader 250, filtered by baseband filters 260 and 262, and modulated onto the carrier frequency by modulator 270 and 272, and summed up by summer 280 to produce the transmitted waveform S(t), as shown in FIG. 2.

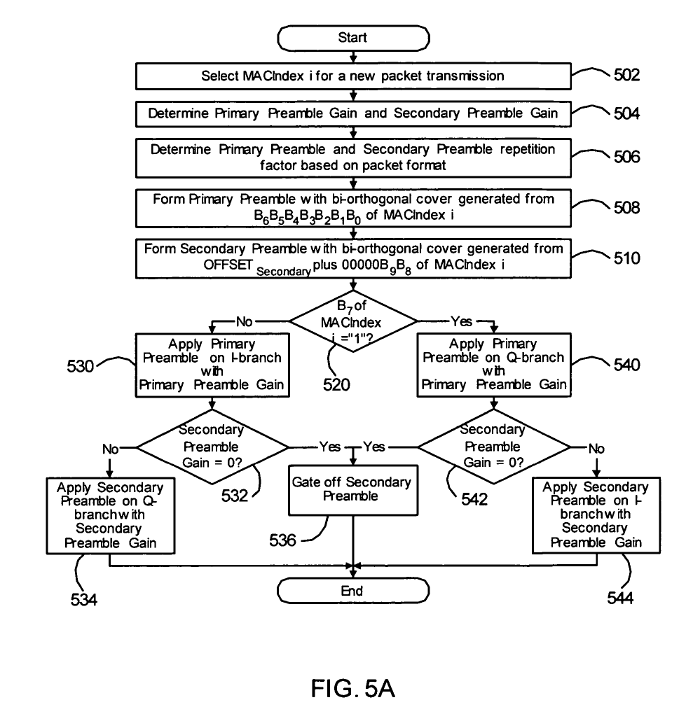

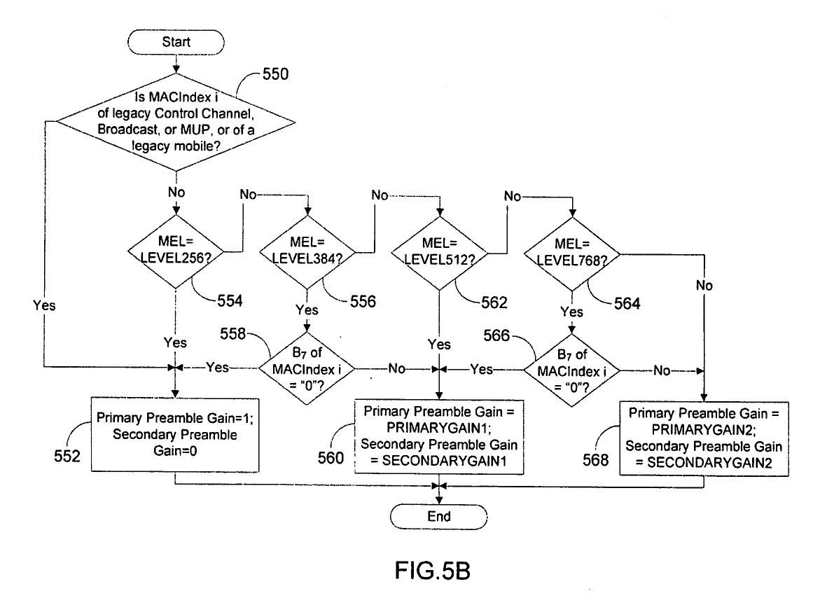

FIG. 5A illustrates the base station procedures for transmitting the Primary Preamble and the Secondary Preamble according to the first embodiment of the present invention. Referring to FIG. 5A, the base station selects the MACIndex i for the scheduled transmission of a new data packet in step 502. This MACIndex i can be an individual MACIndex for a legacy mobile or a new mobile, or it can be a common MACIndex for the legacy Control Channel, Broadcast, or Multi-User Packet transmission. The base station then determines the Primary Preamble Gain and the Secondary Preamble Gain in step 504 and the preamble repetition factor in step 506 according to the transmitted packet format. In step 508, the base station forms the Primary Preamble with the 64-chip bi-orthogonal cover using the seven least significant bits B₆B₅B₄B₃B₂B₁B₀ of the MACIndex i. In step 510, the base station forms the Secondary Preamble with the 64-chip bi-orthogonal cover using the sum of OFFSET_{Secondary} and 00000B₉B₈, where B₉B₈ are the two most significant bits B₉B₈ of the MACIndex i. In step 520, the base station determines whether the bit B₇ of the MACIndex i is “1” or “0”. If the bit B₇ of the MACIndex i is “0”, the base station applies the Primary Preamble on the I-branch with the Primary Preamble Gain in step 530. Further in step 532, the base station determines whether the Secondary Preamble Gain is zero. If it is zero, the base station applies the Secondary Preamble with zero power, therefore gating off the transmission of the Secondary Preamble, in step 536. If it is not zero, the base station applies the Secondary Preamble on the Q-branch with the Secondary Preamble Gain in step 534. If the bit B₇ of the MACIndex i is “1”, the base station applies the Primary Preamble on the Q-branch with the Primary Preamble Gain in step 540. Further in step 542, the base station determines whether the Secondary Preamble Gain is zero. If it is zero, the base station applies the Secondary Preamble with zero power, therefore gating off the transmission of the Secondary Preamble, in step 536. If it is not zero, the base station applies the Secondary Preamble on the I-branch with the Secondary Preamble Gain in step 544.

FIG. 5B further illustrates, the base station procedures for determining the Primary Preamble Gain and the Secondary Preamble Gain in step 504 in greater details, according to the first embodiment of the present invention. Referring to FIG. 5B, in step 550, the base station first determines whether the MACIndex i is for the transmission of a legacy mobile or legacy Control Channel, Broadcast, or Multi-User Packet (MUP). If it is for legacy transmission, the base station sets the Primary Preamble Gain to 1, meaning with full power, and the Secondary Preamble Gain to zero, meaning with zero power or gated off, in step 552. If it is not for legacy transmission, the base station further determines whether the current MACIndex Extension Level (MEL) is LEVEL256 in step 554. LEVEL256 is the MACIndex Extension Level where a maximal number of 256 MACIndex values can be supported, except for those MACIndex values of which the seven least significant bits B₆B₅B₄B₃B₂B₁B₀ have the value of 0, 1, 64, or 65, as these values may cause the receiver to mistake the preamble signal as Pilot 120 signal. Table 1 below shows the assignments of MACIndex values and the orders of bi-orthogonal covers on the hypothesized Secondary Preambles in LEVEL256.

TABLE 1

| | | | Secondary |
|---|---|---|---|
| | Primary | Secondary | Preamble |
| MACIndex Value | Preamble | Preamble | Hypotheses |
| 2˜63 and 66˜127 | On I-branch | Gated off | None |
| 130˜191 and 194˜255 | On Q-branch | Gated off | None |

If the current MACIndex Extension Level is LEVEL256, the base station sets the Primary Preamble Gain to 1, meaning with full power, and the Secondary Preamble Gain to zero, meaning with zero power or gated off, in step 552. If it is not LEVEL256, the base station further determines whether the current MACIndex Extension Level is LEVEL384 in step 556. LEVEL384 is the MACIndex Extension Level where a maximal number of 384 MACIndex values can be supported, except for those MACIndex values of which the seven least significant bits B₆B₅B₄B₃B₂B₁B₀ have the value of 0, 1, 64, or 65. Table 2 below shows the assignments of MACIndex values and the orders of bi-orthogonal covers on the hypothesized Secondary Preambles in LEVEL384.

TABLE 2

| | | | Secondary |
|---|---|---|---|
| | Primary | Secondary | Preamble |
| MACIndex Value | Preamble | Preamble | Hypotheses |
| 2˜63 and 66˜127* | On I-branch | Gated off | None |
| 130˜191, 194˜255, | On Q-branch | On I-branch | OFFSET_{Secondary} |
| 386˜447, and | | | and |
| 450˜511 | | | OFFSET_{Secondary} + 1 |

Where * denotes excluding the values of OFFSET_{Secondary} and OFFSET_{Secondary}+1.

If the current MACIndex Extension Level is LEVEL384, the base station further determines whether the bit B₇ of MACIdenx i is “0” or “1” in step 558. If it is “0”, the base station sets the Primary Preamble Gain to 1, meaning with full power, and the Secondary Preamble Gain to zero, meaning with zero power or gated off, in step 552. If the bit B₇ of MACIdenx i is “1”, the base station sets the Primary Preamble Gain to PRIMARYGAIN1 and the Secondary Preamble Gain to SECONDARYGAIN1 in step 560. If the current MACIndex Extension Level is not LEVEL384, the base station further determines whether the current MACIndex Extension Level is LEVEL512 in step 562. LEVEL512 is the MACIndex Extension Level where a maximal number of 512 MACIndex values can be supported in the system, except for those MACIndex values of which the seven least significant bits B₆B₅B₄B₃B₂B₁B₀ have the value of 0, 1, 64, or 65. Table 3 below shows the assignments of MACIndex values and the orders of bi-orthogonal covers on the hypothesized Secondary Preambles in LEVEL512.

TABLE 3

| | | | Secondary |
|---|---|---|---|
| | Primary | Secondary | Preamble |
| MACIndex Value | Preamble | Preamble | Hypotheses |
| 2˜63, 66˜127, | On I- | Gated off for | None for legacy |
| 258˜319, and | branch | legacy | transmissions; |
| 322˜383^{$,}* | | transmissions; | otherwise |
| | | otherwise, on | OFFSET_{Secondary} and |
| | | Q-branch | OFFSET_{Secondary} + 1 |
| 130˜191, 194˜255, | On Q- | On I-branch | OFFSET_{Secondary} and |
| 386˜447, and | branch | | OFFSET_{Secondary} + 1 |
| 450˜511* | | | |

where ^{$} denotes excluding those MACIndex values of which the bits B₆B₅B₄B₃B₂B₁B₀ have the same value as any MACIndex values that are already assigned for a legacy mobile or legacy Control Channel, Broadcast, or Multi-User Packet transmission, and * denotes excluding those MACIndex values of which the bits B₆B₅B₄B₃B₂B₁B₀ have the same value as OFFSET_{Secondary} or OFFSET_{Secondary}+1.

If the current MACIndex Extension Level is LEVEL512, the base station sets the Primary Preamble Gain to PRIMARYGAIN1 and the Secondary Preamble Gain to SEOMCDARYGAIN1 in step 560. If it is not LEVEL512, the base station further determines whether the current MACIndex Extension Level is LEVEL768 in step 564. LEVEL768 is the MACIndex Extension Level where a maximal number of 768 MACIndex values can be supported in the system, except for those MACIndex values of which the seven least significant bits B₆B₅B₄B₃B₂B₁B₀ have the value of 0, 1, 64, or 65. Table 4 below shows the assignments of MACIndex values and the orders of bi-orthogonal covers on the hypothesized Secondary Preambles in LEVEL768.

TABLE 4

| | | | Secondary |
|---|---|---|---|
| | Primary | Secondary | Preamble |
| MACIndex Value | Preamble | Preamble | Hypotheses |
| 2˜63, 66˜127, | On I- | Gated off for | None for legacy |
| 258˜319, and | branch | legacy | transmissions; |
| 322˜383^{#,$} | | transmissio; | otherwise |
| | | otherwise, on | OFFSET_{Secondary} and |
| | | Q-branch | OFFSET_{Secondary} + 1 |
| 130˜191, | On Q- | On I-branch | OFFSET_{Secondary}, |
| 194˜255, | branch | | OFFSET_{Secondary} + 1, |
| 386˜447, | | | OFFSET_{Secondary} + 2, |
| 450˜511, | | | and |
| 642˜703, | | | OFFSET_{Secondary} + 3 |
| 706˜767, | | | |
| 898˜959, and | | | |
| 962˜1023* | | | |

where ^{#} denotes excluding those MACIndex values of which the bits B₆B₅B₄B₃B₂B₁B₀ have the same value as OFFSET_{Secondary}, OFFSET_{Secondary}+1, OFFSET_{Secondary}+2, or OFFSET_{Secondary}+3; ^{$} denotes excluding those MACIndex values of which the bits B₆B₅B₄B₃B₂B₁B₀ have the same value as any MACIndex values that are already assigned for a legacy mobile or legacy Control Channel, Broadcast, or Multi-User Packet transmission; and * denotes excluding those MACIndex values of which the bits B₆B₅B₄B₃B₂B₁B₀ have the same value as OFFSET_{Secondary} or OFFSET_{Secondary}+1.

If the current MACIndex Extension Level is LEVEL768, the base station further determines whether the bit B₇ of MACIdenx i is “0” or “1” in step 566. If it is “0”, the base station sets the Primary Preamble Gain to PRIMARYGAIN1 and the Secondary Preamble Gain to SECONDARYGAIN1 in step 560. If the bit B7 of MACIdenx i is “1”, the base station sets the Primary Preamble Gain to PRIMARYGAIN2 and the Secondary Preamble Gain to SECONDARYGAIN2 in step 568. If the current MACIndex Extension Level is not LEVEL768, the base station sets the Primary Preamble Gain to PRIMARYGAIN2 and the Secondary Preamble Gain to SECONDARYGAIN2 in step 568, and the base station considers the current MACIndex Extension Level is LEVEL1024. LEVEL1024 is the MACIndex Extension Level where a maximal number of 1024 MACIndex values can be supported in the system, except for those MACIndex values of which the seven least significant bits B₆B₅B₄B₃B₂B₁B₀ have the value of 0, 1, 64, or 65. Table 5 below shows the assignments of MACIndex values and the orders of bi-orthogonal covers on the hypothesized Secondary Preamble in LEVEL1024.

TABLE 5

| MACIndex | Primary | Secondary | Secondary Preamble |
|---|---|---|---|
| Value | Preamble | Preamble | Hypotheses |
| 2˜63, 66˜127, | On I- | Gated off for | None for legacy |
| 258˜319, | branch | legacy | transmissions; |
| 322˜383, | | transmission; | otherwise |
| 514˜575, | | otherwise, on | OFFSET_{Secondary}, |
| 578˜639, | | Q-branch | OFFSET_{Secondary} + 1, |
| 770˜831, and | | | OFFSET_{Secondary} + 2, and |
| 834˜895^{#,$} | | | OFFSET_{Secondary} + 3 |
| 130˜191, | On Q- | On I-branch | OFFSET_{Secondary}, |
| 194˜255, | branch | | OFFSET_{Secondary} + 1, |
| 386˜447, | | | OFFSET_{Secondary} + 2, and |
| 450˜511, | | | OFFSET_{Secondary} + 3 |
| 642˜703, | | | |
| 706˜767, | | | |
| 898˜959, and | | | |
| 962˜1023^{#} | | | |

where ^{#} denotes excluding those MACIndex values of which the bits B₆B₅B₄B₃B₂B₁B₀ have the same value as OFFSET_{Secondary}, OFFSET_{Secondary}+1 OFFSET_{Secondary}+2, or OFFSET_{Secondary}+3, and ^{$} denotes excluding those MACIndex values of which the bits B₆B₅B₄B₃B₂B₁B₀ have the same value as any MACIndex values that are already assigned for a legacy mobile or legacy Control Channel, Broadcast, or Multi-User Packet transmission.

The PRIMARYGAIN1, SECONDARYGAIN1, PRIMARYGAIN2, and SECONDARYGAIN2 maintain a constant total transmit power on the complex preamble signal and satisfy the following conditions:
PRIMARYGAIN1≧SECONDARYGAIN1>0 (6)
PRIMARYGAIN2≧SECONDARYGAIN2>0 (7)
PRIMARYGAIN1≧PRIMARYGAIN2 (8)
SECONDARYGAIN2≧SECONDARYGAIN1 (9)

Although, FIG. 5B uses the decision points one after another to determine the gains for the current MACIndex Extension Level for illustration purpose, it is readily apparent to those skilled in the art that the embodiment of using a selector switch to directly reach the current MACIndex Extension Level is within the scope of the present invention. Based on the description above and the illustration in FIG. 5B, the MACIndex Extension Level can be further extended beyond LEVEL1024 if more than 1024 MACIndex values are needed. In addition, any subset of the MACIndex Extension Levels that contains at least one MACIndex Extension Level as illustrated in FIG. 5B may be chosen for implementation.

At each MACIndex Extension Level, the design of the Primary Preamble and the Secondary Preamble structure and the use of bit B₇ of the MACIndex ensure that the Primary Preamble is always transmitted on the I-branch for the legacy mobile stations and for legacy Control Channel, Broadcast, and Multi-User Packet transmissions, as their respective MACIndex values are always less than 128, i.e. the bit B₇ of the MACIndex is “0”. The base station transmission procedures also ensure that the Primary Preamble Gain is set to 1, meaning with full power, and the Secondary Preamble Gain is set to 0, meaning with zero power or gated off, for these legacy transmissions. Therefore, the same preamble performance as in the legacy system is expected for these legacy transmissions in the new system.

It is an object of the present invention to be able to distinguish the Primary Preamble that is for one mobile station and the Secondary Preamble that is for another mobile station on the same branch. Therefore, the 64-chip bi-orthogonal covers used on the Primary Preamble, which are generated from the seven least significant bits B₆B₅B₄B₃B₂B₁B₀ of the MACIndex value of the first mobile station mentioned above, should not duplicate with the 64-chip bi-orthogonal covers used on the Secondary Preamble on the same branch, which are generated from the sum of OFFSET_{Secondary} and 00000B₉B₈, where B₉B₈ are the two most significant bits B₉B₈ of the MACIndex value of the second mobile station mentioned above. The OFFSET_{Secondary} is designed to allow the system to select the Secondary Preamble 64-chip bi-orthogonal covers flexibly. The OFFSET_{Secondary} can be fixed values or the base station may select it flexibly, for example when the MACIndex Extension Level changes, and inform the mobile stations about the change in signaling messages. The base station also informs the mobile stations about the MACIndex Extension Level that it is using through signaling messages. The base station may optionally provide the mobile stations with the values of PRIMARYGAIN1 and SECONDARYGAIN1, and/or the values of PRIMARYGAIN2 and SECONDARYGAIN2 in the signaling messages to facilitate the implementation of advanced detection algorithms at the mobile receiver.

At the beginning of each time slot, the mobile stations not only needs to detect the preamble that contains its own MACIndex value, but also needs to detect the preambles that contain the MACIndex values for the Control Channel, Broadcast if such service is enabled for the mobile station, and Multi-User Packet if the mobile station is enabled to receive the Multi-User Packet, because any of these types of packet could be transmitted at the current time slot. Each preamble associated with these MACIndex values has one corresponding preamble length. For example, the preamble under test that would contain the mobile station's MACIndex value has a preamble length that is determined by the DRC message that the mobile station sent. The preamble under test that would contain a MACIndex value of the Control Channel or Multi-User Packet has a fixed preamble length specified by the IS-856 standards. The preamble under test that would contain the Broadcast MACIndex value has a preamble length that is determined by the data rate of the Broadcast service, which is known to both the base station and the mobile station.

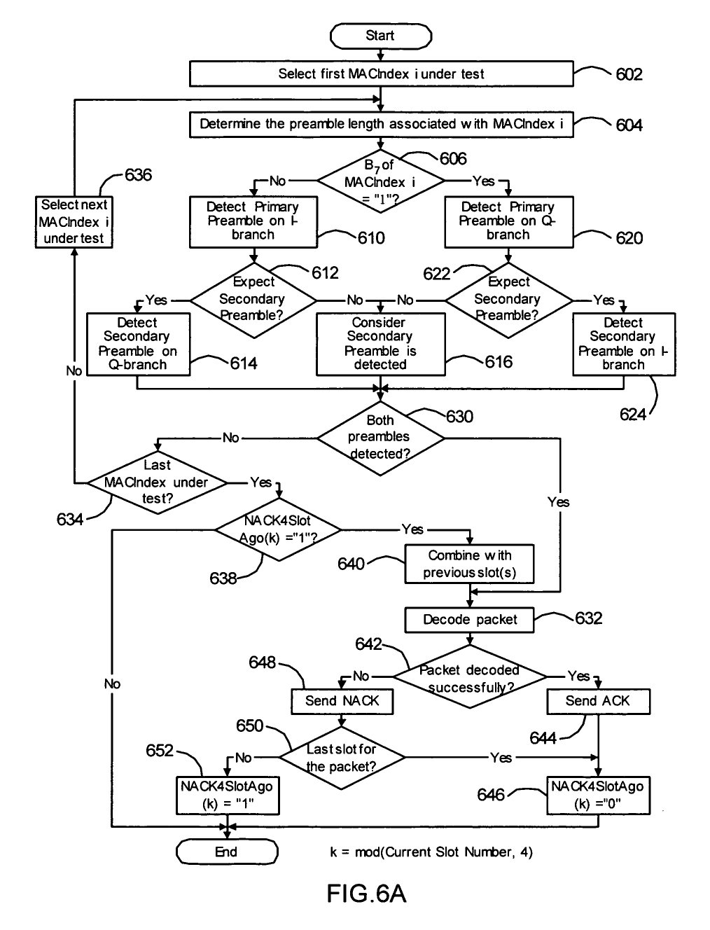

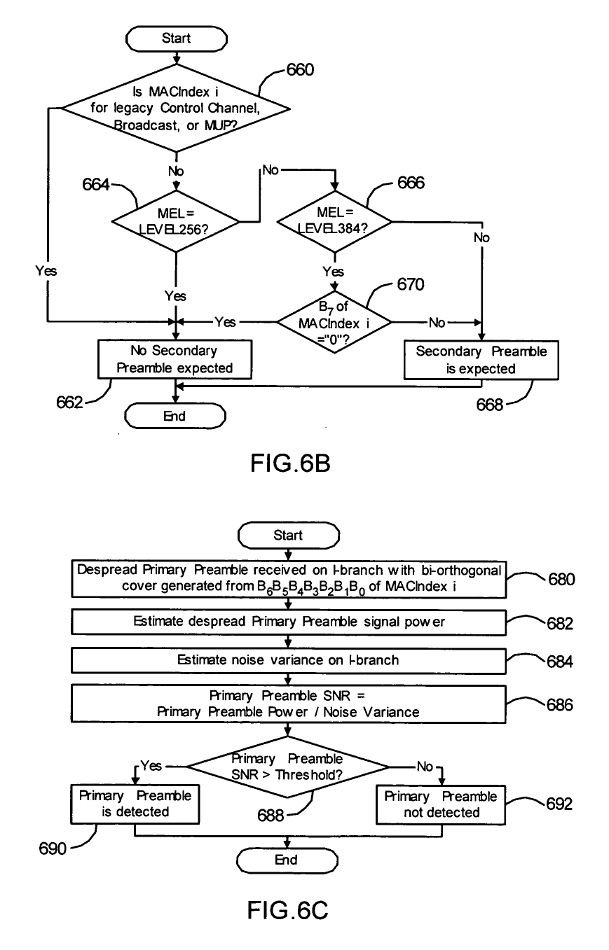

FIG. 6A illustrates the mobile station procedures for detecting the Primary Preamble, the Secondary Preamble, and the data packet, according to the first embodiment of the present invention. Referring to FIG. 6A, the mobile station selects the first MACIndex i that needs to be tested in step 602. In step 604, the mobile station determines the length of the preamble associated with the MACIndex i as described above. In step 606, the mobile station determines whether the bit B₇ of MACIndex i is “0” or “1”. If the bit B₇ of MACIndex i is “0”, the mobile station detects the Primary Preamble on I-branch in step 610 with a preamble length determined in step 604. Then, the mobile station determines whether the Secondary Preamble is expected to be present with non-zero power in step 612, given the MACIndex i and the current MACIndex Extension Level. If the Secondary Preamble is expected to be present, the mobile station detects the Secondary Preamble on Q-branch in step 614 with a preamble length determined in step 604. If the Secondary Preamble is not expected to be present, the mobile station considers the Secondary Preamble is detected in step 616. If the bit B₇ of MACIndex i is “1”, the mobile station detects the Primary Preamble on Q-branch in step 620 with a preamble length determined in step 604. Then, the mobile station determines whether the Secondary Preamble is expected to be present with non-zero power in step 622, given the MACIndex i and the current MACIndex Extension Level. If the Secondary Preamble is expected to be present, the mobile station detects the Secondary Preamble on I-branch in step 624 with a preamble length determined in step 604. If the Secondary Preamble is not expected to be present, the mobile station considers the Secondary Preamble is detected in step 616. In step 630, the mobile station determines whether both the Primary Preamble and the Secondary Preamble for MACIndex i are detected. If both preambles are detected, the mobile station tries to decode the Physical Layer packet in step 632. If either of the two preambles is not detected, the mobile station determines whether it has tested all MACIndex values that it needs to test in step 634. If not, the mobile station selects the next MACIndex i that needs to be test in step 636, then repeat the steps from step 604 to step 630. If the mobile station has tested all MACIndex values that its needs to test, the mobile station, in step 638, determines whether the flag NACK4SlotAgo(k) is “0” or “1”, where k is the modulus or the remainder after division of the current time slot number by 4, meaning whether it had sent a NACK to the base station 4 time slot ago. If the flag NACK4SlotAgo(k) is “0”, the mobile station waits for the next time slot. If the flag NACK4SlotAgo(k) is “1”, the mobile station soft-combines the data packet in the current time slot with that received 4 slots ago in step 640 and tries to decode it in step 632. In step 642, the mobile station determines whether the Physical Layer packet is decoded successfully. If the Physical Layer packet is decoded successfully, the mobile station sends an ACK signal on its Reverse ACK Channel in step 644 then clears the flag NACK4SlotAgo(k) to “0” in step 646. If the Physical Layer packet is not decoded successfully, the mobile station sends a NACK signal on its Reverse ACK Channel in step 648. Then the mobile station determines whether the failed data packet has exhausted to its last scheduled slot in step 650. If it is the last slot, the mobile station clears the flag NACK4SlotAgo(k) to “0” in step 646. If it is not the last slot, the mobile station sets the flag NACK4SlotAgo(k) to “1” in step 652.

In one embodiment of the present invention, the preferred modulation scheme on the Reverse ACK Channel is Binary Phase Shift Keying (BPSK), i.e. the ACK is sent as “+1” signal and the NACK is sent as “−1” signal.

Although, for illustration purpose, FIG. 6A shows the mobile station procedures for detecting the preambles from step 602 to step 636 in a serial fashion, i.e. one MACIndex after another, parallel detection with steps from step 604 to step 630 for each MACIndex value that the mobile station needs to detect is readily apparent to those skilled in the art and is also within the scope of the present invention.

FIG. 6B further illustrates the mobile station procedures for determining whether the Secondary Preamble is expected to be present with non-zero power in step 612 and in step 622 in greater details, according to the first embodiment of the present invention. Referring to FIG. 6B, the mobile station determines whether the MACIndex i under test is for legacy Control Channel, Broadcast, or Multi-User Packet transmission in step 660. If it is for legacy transmission, the mobile station concludes that the Secondary Preamble is not expected to be present in step 662. If it is not for legacy transmission, the mobile station further determines whether the current MACIndex Extension Level is LEVEL256 in step 664. If it is LEVEL256, the mobile station concludes that the Secondary Preamble is not expected to be present in step 662. If it is not LEVEL256, the mobile station further determines whether the current MACIndex Extension Level is LEVEL384 in step 666. If it is not LEVEL384, the mobile station concludes that the Secondary Preamble is expected to be present, as the MACIndex Extension Level is beyond LEVEL384, in step 668. If it is LEVEL384, the mobile station further determines whether the bit B₇ of MACIndex i is “0” or “1” in step 670. If it is “0”, the mobile station concludes that the Secondary Preamble is not expected to be present in step 662. If it is “1”, the mobile station concludes that the Secondary Preamble is expected to be present in step 668.

FIG. 6C further illustrates the mobile station procedures for detecting the Primary Preamble in step 610 in greater details, according to the first embodiment of the present invention. Referring to FIG. 6C, the mobile station despreads the Primary Preamble received on the I-branch with the bi-orthogonal cover that is generated from the seven least significant bits B₆B₅B₄B₃B₂B₁B₀ of MACIndex i in step 680 and estimates the despread signal power in step 682. The mobile station further estimates the noise variance on the I-branch in step 684. Then the mobile station calculates the Primary Preamble Signal-to-Noise Ratio (SNR) by dividing the Primary Preamble signal power by the noise variance in step 686. The mobile station further determines whether the Primary Preamble SNR is greater than the threshold in step 688. If it is greater than the threshold, the mobile station concludes that the Primary Preamble is detected in step 690. If it is less than the threshold, the mobile station concludes that the Primary Preamble is not detected in step 692. The threshold may be a fixed value or it may be a function of the Primary Preamble Gain, which may be 1, PRIMARYGAIN1, or PRIMARYGAIN2 in the example described above, depending on whether the MACIndex i that the mobile is testing is for legacy transmission and/or which MACIndex Extension Level the base station is using currently. The base station may compute and provide a set of thresholds for the mobile station to use in signaling messages, or the mobile station may compute the thresholds using the information of PRIMARYGAIN1 or PRIMARYGAIN2 that the base station provides in the signaling messages.

It is readily apparent to those skilled in the art that the same procedures illustrated in FIG. 6C can be used to further describe step 620 in greater details, except that the Primary Preamble is received on Q-branch and the mobile station estimates the noise variance on the Q-branch in this case.

The detection of the Secondary Preamble by the mobile station would be more reliable by performing hypothesis testing than by comparing the received Secondary Preamble SNR with a threshold. Hypothesis testing is a process in which all possible signals that are permitted by the protocols or settings are tested against the received signal. The hypothesized signal that results in the maximum a posteriori probability is deemed to be the one transmitted. Unlike the Primary Preamble, which may have more than 100 hypotheses to be tested, the Secondary Preamble, if transmitted, has only two or four hypotheses, all of which can be readily tested by the mobile stations.

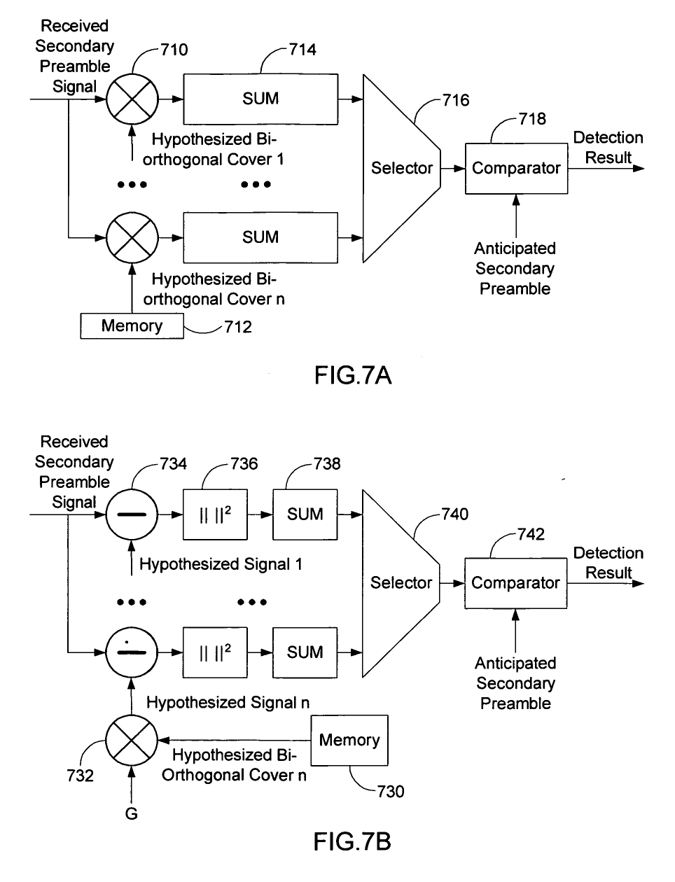

FIG. 7A shows one embodiment of a method and apparatus for performing the hypothesis testing by the mobile station, the method comprising: despreading the Secondary Preamble signal received in step 614 or in step 624 by despreader 710 with each bi-orthogonal sequence that is generated from the Secondary Preamble hypotheses, which are stored in memory 712, as shown in Table 2 if the current MACIndex Extension Level is LEVEL384, or as shown in Table 3 if the current MACIndex Extension Level is LEVEL512, or as shown in Table 4 if the current MACIndex Extension Level is LEVEL768, or as shown in Table 5 if the current MACIndex Extension Level is LEVEL1024; summing up the despread signals by summer 714 for the preamble length determined in step 604 for each hypothesis; selecting the hypothesis that produces the highest summed value by selector 716; comparing the order of the bi-orthogonal cover of the selected hypothesis with the sum of OFFSET_{Secondary} and 00000B₉B₈, where B₉B₈ are the two most significant bits B₉B₈ of the MACIndex i, by comparator 718. If they match, the mobile station concludes that the Secondary Preamble is detected. If they don't match, the mobile station concludes that the Secondary Preamble is not detected.

FIG. 7B shows one embodiment of another method and apparatus for the mobile station performing the hypothesis testing. The method produces a least square estimate of the received Secondary Preamble signal, Sᵣ, based on the following optimization:

$${S}_{d} = {min}_{{h}_{j}} {\sum }_{L} {‖ {S}_{r} - {Gh}_{j} ‖}^{2} \qquad ( 10 )$$

where hⱼ is a hypothesized sequence of bi-orthogonal cover on the Secondary Preamble with appropriate repetition according to the preamble length L, which is determined in step 604, G is the overall Secondary Preamble signal gain factor, including the Secondary Preamble Gain, which may be SECONDARYGAIN1 or SECONDARYGAIN2, and the path loss of the signal amplitude, which can be estimated from the received Pilot 120 signal strength. The optimization in equation (10) is over all hypotheses, as shown in Table 2 if the current MACIndex Extension Level is LEVEL384, or as shown in Table 3 if the current MACIndex Extension Level is LEVEL512, or as shown in Table 4 if the current MACIndex Extension Level is LEVEL768, or as shown in Table 5 if the current MACIndex Extension Level is LEVEL1024. The least square estimate S_{d} is the hypothesis that results in the minimum error between the received Secondary Preamble signal and the hypothesized sequence of bi-orthogonal cover adjusted by the gain factor of G. Referring to FIG. 7B, memory 730 produces n hypothesized bi-orthogonal sequences. Multiplier 732 scales each of them with the gain G described above. Subtraction element 734 then subtracts the received Secondary Preamble signal from each scaled hypothesized signal. Squaring element 736 then takes the square of each output of the subtraction element. Summer 738 then sums up the squared signal over the preamble length determined in step 604. Selector 740 selects the hypothesis that results in the minimum summed output. Comparator 742 then compares the order of the bi-orthogonal cover of the selected hypothesis with the sum of OFFSET_{Secondary} and 00000B₉B₈, where B₉B₈ are the two most significant bits B₉B₈ of the MACIndex i. If they match, the mobile station concludes that the Secondary Preamble is detected. If they don't match, the mobile station concludes that the Secondary Preamble is not detected. The base station may provide the mobile stations with the information of SECONDARYGAIN1 and/or SECONDARYGAIN2 in signaling messages to facilitate the implementation of such a method.

The detection of the Secondary Preamble is more reliable than the detection of the Primary Preamble if equal amounts of transmit power are applied on the Primary Preamble and the Secondary Preamble. As a result, more power can be applied on the Primary Preamble than on the Secondary Preamble to improve the overall preamble performance. Furthermore, as the number of hypotheses on the Secondary Preamble increases as the MACIndex Extension Level changes from LEVEL384, to LEVEL512, to LEVEL768, and to LEVEL1024, the transmit power can be shifted from the Primary Preamble to the Secondary Preamble gradually so that the impact on the overall preamble performance is minimized for a given number of MACIndex values that the base station is set to support. In general, the traffic density, thereof the needs for more MACIndex values, tends to be high in the smaller cells in the urban environment where the preamble signal coverage is not an issue. Meanwhile, the larger cells in the suburban or rural areas may not need as many MACIndex values for lack of data traffic. Therefore, the design of multiple MACIndex Extension Levels provides the flexibility to adapt to the traffic density and cell coverage conditions. The use of bit B₇ of MACIndex to split the MACIndex values between the I-branch and the Q-branch also helps to reduce the number of hypothesized signals on the Secondary Preamble, therefore improving the overall preamble performance.

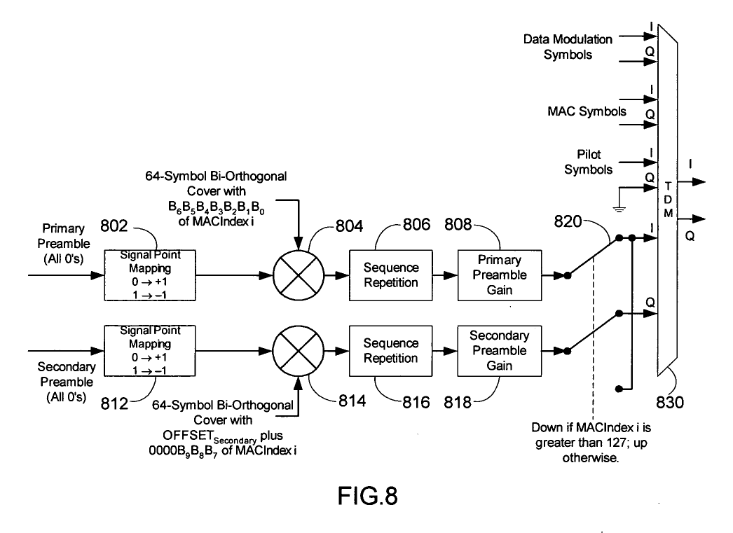

FIG. 8 illustrated the channel structure of the Primary Preamble and the Secondary Preamble according to the second embodiment of the present invention. Referring to FIG. 8, the preamble consists of two parts, the Primary Preamble and the Secondary Preamble. The Primary Preamble sequence and the Secondary Preamble sequence consist of all-“0” symbols. Signal Point Mapping elements 802 and 812 map the all-“0” symbols into “+1” sequences. The output sequences are spread by multipliers 804 and 814 with a 64-chip bi-orthogonal cover. The 64-chip bi-orthogonal cover on the Primary Preamble is generated from the seven least significant bits B₆B₅B₄B₃B₂B₁B₀ of the MACIndex according to equations (3) and (4), where the order i is the value of B₆B₅B₄B₃B₂B₁B₀ of the MACIndex. The 64-chip bi-orthogonal cover on the Secondary Preamble is generated from the three most significant bits B₉B₈B₇ of the MACIndex according to equations (3) and (4), where the order i is the value of the sum of OFFSET_{Secondary} and 0000B₉B₈B₇. The OFFSET_{Secondary} is an integer number known to both the base station and the mobile stations. The sum of OFFSET_{Secondary} and 0000B₉B₈B₇ has a value less than 128 but cannot have the values of 0, 1, 64, or 65, as these values may cause the receiver to mistake the Secondary Preamble signal as Pilot 120 signal. In addition, if the MACIndex Extension Level allows the Secondary Preamble to be transmitted with non-zero power on the I-branch, the sum of OFFSET_{Secondary} and 0000B₉B₈B₇ cannot have the same value as any MACIndex values that have already been assigned for a legacy mobile or for legacy Control Channel, Broadcast, or Multi-User Packet transmissions. Sequence repeaters 806 and 816 produce the repetition of the bi-orthogonal covered sequences with a repetition factor of 1 to 16, according to the preamble length. Then the Primary Preamble signal is scaled by Primary Preamble Gain element 808 and the Secondary Preamble signal is scaled by Secondary Preamble Gain element 818. The Primary Preamble Gain and the Secondary Preamble Gain maintain a constant total transmit power on the complex preamble signal. Double-pole double-throw switch 820 applies the Primary Preamble signal (with full power) onto the I-branch and the Secondary Preamble signal (with zero power) onto the Q-branch if the MACIndex i value is less than or equals to 127; or it applies the Primary Preamble signal (with less than full power) onto the Q-branch and the Secondary Preamble signal (with non-zero power) onto the I-branch if the MACIndex i value is greater than 127. Thus the Primary Preamble and the Secondary Preamble are not transmitted on the same branch at the same time. The complex preamble signal is then time-division multiplexed (TDM) by multiplexer 830 with the complex signals of Data 140 modulation symbols, Pilot 120 symbols, and MAC 130 symbols, as illustrated in FIG. 1. The time-division multiplexed signals are further spread by complex spreader 250, filtered by baseband filters 260 and 262, and modulated onto the carrier frequency by modulator 270 and 272, and summed up by summer 280 to produce the transmitted waveform S(t), as shown in FIG. 2.

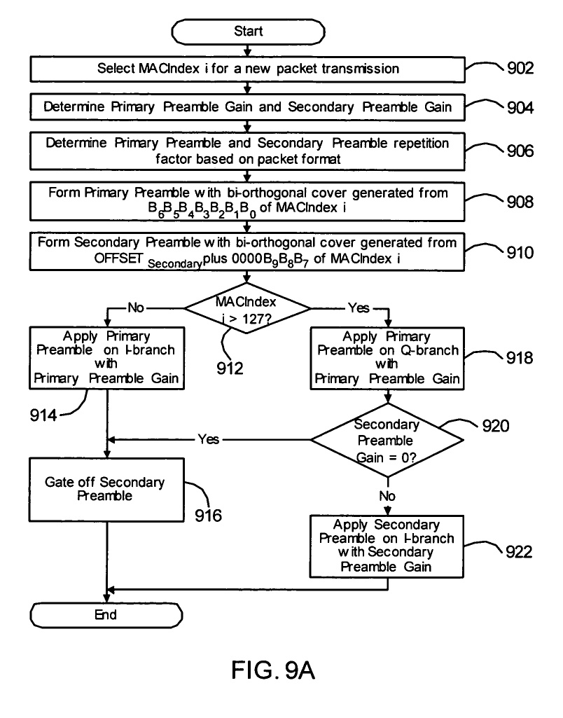

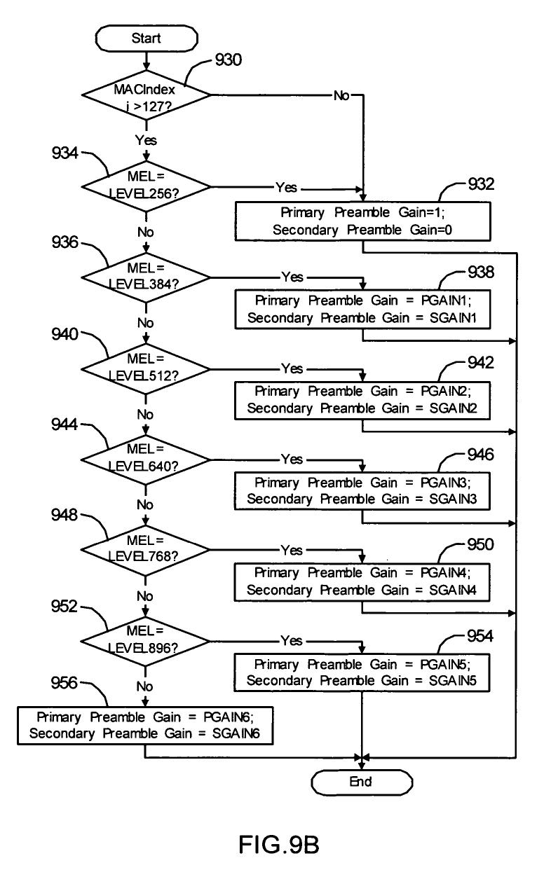

FIG. 9A illustrates the base station procedures for transmitting the Primary Preamble and the Secondary Preamble according to the second embodiment of the present invention. Referring to FIG. 9A, the base station selects the MACIndex i for the scheduled transmission of a new data packet in step 902. This MACIndex i can be an individual MACIndex for a legacy mobile or a new mobile, or it can be a common MACIndex for the legacy Control Channel, Broadcast, or Multi-User Packet transmission. The base station then determines the Primary Preamble Gain and the Secondary Preamble Gain in step 904 and the preamble repetition factor according to the transmitted packet format in step 906. In step 908, the base station forms the Primary Preamble with the 64-chip bi-orthogonal cover using the seven least significant bits B₆B₅B₄B₃B₂B₁B₀ of the MACIndex i. In step 910, the base station forms the Secondary Preamble with the 64-chip bi-orthogonal cover using the sum of OFFSET_{Secondary} and 0000B₉B₈B₇, where B₉B₈B₇ are the three most significant bits B₉B₈B₇ of the MACIndex i. In step 912, the base station determines whether the MACIndex i value is greater than 127. If the MACIndex i value is not greater than 127, the base station applies the Primary Preamble on the I-branch with the Primary Preamble Gain of 1, meaning with full power, in step 914. Further in step 916, the base station applies the Secondary Preamble with zero power, therefore gating off the transmission of the Secondary Preamble. If the MACIndex i value is greater than 127, the base station applies the Primary Preamble on the Q-branch with the Primary Preamble Gain in step 918. Further in step 920, the base station determines whether the Secondary Preamble Gain is zero. If it is zero, the base station applies the Secondary Preamble with zero power, therefore gating off the transmission of the Secondary Preamble, in step 916. If it is not zero, the base station applies the Secondary Preamble on the I-branch with the Secondary Preamble Gain in step 922.

FIG. 9B further illustrates the base station procedures for determining the Primary Preamble Gain and the Secondary Preamble Gain in step 904 in greater details, according to the second embodiment of the present invention. Referring to FIG. 9B, in step 930, the base station first determines whether the MACIndex i value is greater than 127. If it is not greater than 127, the base station sets the Primary Preamble Gain to 1, meaning with full power, and the Secondary Preamble Gain to zero, meaning with zero power or gated off, in step 932. If the MACIndex i value is greater than 127, the base station further determines whether the current MACIndex Extension Level (MEL) is LEVEL256 in step 934. LEVEL256 is the MACIndex Extension Level where a maximal number of 256 MACIndex values (0˜255) can be supported. If the current MACIndex Extension Level is LEVEL256, the base station sets the Primary Preamble Gain to 1, meaning with full power, and the Secondary Preamble Gain to zero, meaning with zero power or gated off, in step 932.

If the current MACIndex Extension Level is not LEVEL256, the base station further determines whether the current MACIndex Extension Level is LEVEL384 in step 936. LEVEL384 is the MACIndex Extension Level where a maximal number of 384 MACIndex values (0˜383) can be supported, except for the values of OFFSET_{Secondary}+1 and OFFSET_{Secondary}+2, which are used for the Secondary Preamble covers. If the current MACIndex Extension Level is LEVEL384, the base station sets the Primary Preamble Gain to PGAIN1 and the Secondary Preamble Gain to SGAIN1 in step 938.

If the current MACIndex Extension Level is not LEVEL384, the base station further determines whether the current MACIndex Extension Level is LEVEL512 in step 940. LEVEL512 is the MACIndex Extension Level where a maximal number of 512 MACIndex values (0˜511) can be supported in the system, except for the values of OFFSET_{Secondary}+1, OFFSET_{Secondary}+2, and OFFSET_{Secondary}+3, which are used for the Secondary Preamble covers. If the current MACIndex Extension Level is LEVEL512, the base station sets the Primary Preamble Gain to PGAIN2 and the Secondary Preamble Gain to SGAIN2 in step 942.

If the current MACIndex Extension Level is not LEVEL512, the base station further determines whether the current MACIndex Extension Level is LEVEL640 in step 944. LEVEL640 is the MACIndex Extension Level where a maximal number of 640 MACIndex values (0˜639) can be supported in the system, except for the values of OFFSET_{Secondary}+1, OFFSET_{Secondary}+2, OFFSET_{Secondary}+3, and OFFSET_{Secondary}+4, which are used for the Secondary Preamble covers. If the current MACIndex Extension Level is LEVEL640, the base station sets the Primary Preamble Gain to PGAIN3 and the Secondary Preamble Gain to SGAIN3 in step 946.

If the current MACIndex Extension Level is not LEVEL640, the base station further determines whether the current MACIndex Extension Level is LEVEL768 in step 948. LEVEL768 is the MACIndex Extension Level where a maximal number of 768 MACIndex values (0˜767) can be supported in the system, except for the values of OFFSET_{Secondary}+1, OFFSET_{Secondary}+2, OFFSET_{Secondary}+3, OFFSET_{Secondary}+4, and OFFSET_{Secondary}+5, which are used for the Secondary Preamble covers. If the current MACIndex Extension Level is LEVEL768, the base station sets the Primary Preamble Gain to PGAIN4 and the Secondary Preamble Gain to SGAIN4 in step 950.

If the current MACIndex Extension Level is not LEVEL768, the base station further determines whether the current MACIndex Extension Level is LEVEL896 in step 952. LEVEL896 is the MACIndex Extension Level where a maximal number of 896 MACIndex values (0˜895) can be supported in the system, except for the values of OFFSET_{Secondary}+1, OFFSET_{Secondary}+2, OFFSET_{Secondary}+3, OFFSET_{Secondary}+4, OFFSET_{Secondary}+5, and OFFSET_{Secondary}+6, which are used for the Secondary Preamble covers. If the current MACIndex Extension Level is LEVEL896, the base station sets the Primary Preamble Gain to PGAIN5 and the Secondary Preamble Gain to SGAIN5 in step 954.

If the current MACIndex Extension Level is not LEVEL896, the base station sets the Primary Preamble Gain to PGAIN6 and the Secondary Preamble Gain to SGAIN6 in step 956, and the base station considers the current MACIndex Extension Level is LEVEL1024. LEVEL1024 is the MACIndex Extension Level where a maximal number of 1024 MACIndex values can be supported in the system, except for the values of OFFSET_{Secondary}+1, OFFSET_{Secondary}+2, OFFSET_{Secondary}+3, OFFSET_{Secondary}+4, OFFSET_{Secondary}+5, OFFSET_{Secondary}+6, and OFFSET_{Secondary}+7, which are used for the Secondary Preamble covers.

The relative gains PGAIN1 and SGAIN1, PGAIN2 and SGAIN2, PGAIN3 and SGAIN3, PGAIN4 and SGAIN4, PGAIN5 and SGAIN5, PGAIN6 and SGAIN6 maintain a constant total transmit power on the complex preamble signal and satisfy the following conditions:
PGAIN1≧PGAIN2≧PGAIN3≧PGAIN4≧PGAIN5≧PGAIN6≧SGAIN6≧SGAIN5≧SGAIN4≧SGAIN3≧SGAIN2≧SGAIN1>0 (11)

Although, FIG. 9B uses the decision points one after another to determine the gains for the current MACIndex Extension Level for illustration purpose, it is readily apparent to those skilled in the art that the embodiment of using a selector switch to directly reach the current MACIndex Extension Level is within the scope of the present invention. Based on the description above and the illustration in FIG. 9B, the MACIndex Extension Level can be further extended beyond LEVEL1024 if more than 1024 MACIndex values are needed. In addition, any subset of the MACIndex Extension Levels that contains at least one MACIndex Extension Level as illustrated in FIG. 9B may be chosen for implementation.

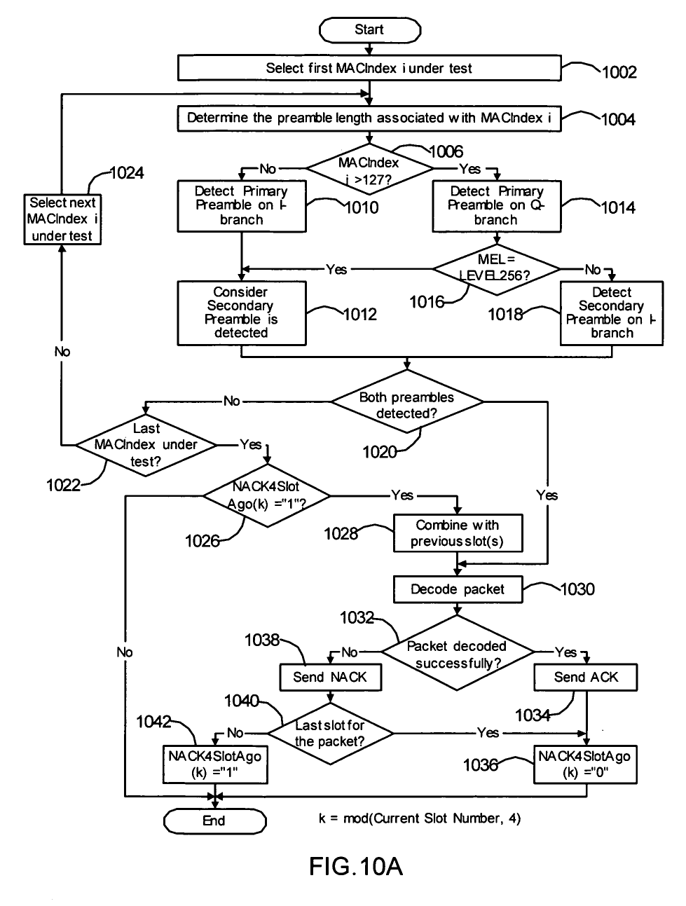

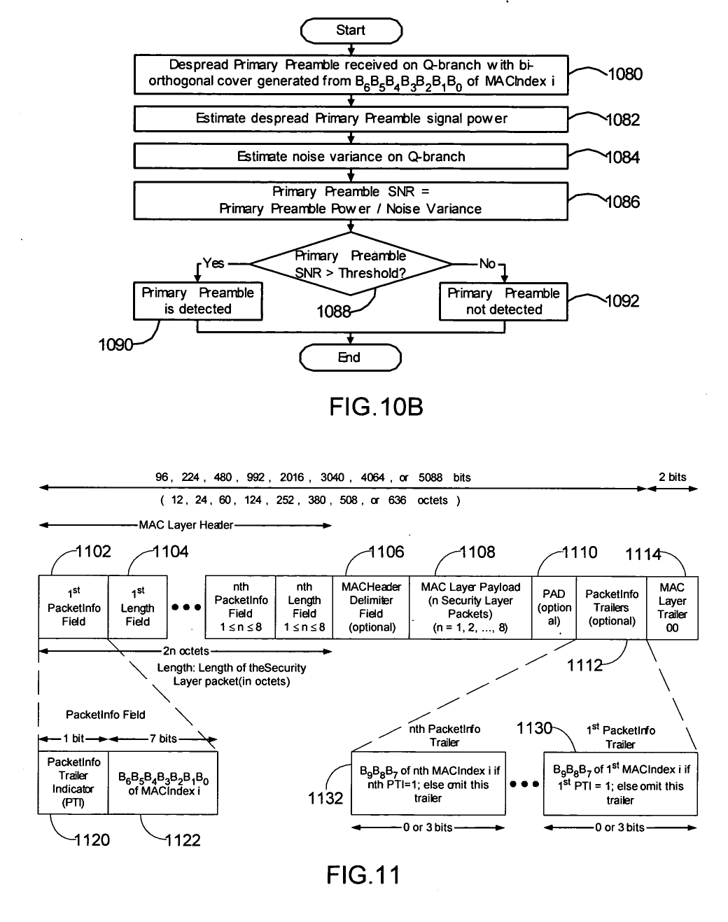

FIG. 10A illustrates the mobile station procedures for detecting the Primary Preamble, the Secondary Preamble, and the data packet, according to the second embodiment of the present invention. Referring to FIG. 10A, the mobile station selects the first MACIndex i that needs to be tested in step 1002. In step 1004, the mobile station determines the length of the preamble associated with the MACIndex i as described above. In step 1006, the mobile station determines whether the MACIndex i value is greater than 127. If the MACIndex i value is not greater than 127, the mobile station detects the Primary Preamble on I-branch in step 1010 with a preamble length determined in step 1004. Then, the mobile station considers the Secondary Preamble is detected in step 1012. If the MACIndex i value is greater than 127, the mobile station detects the Primary Preamble on Q-branch in step 1014 with a preamble length determined in step 1004. Then, the mobile station determines whether the MACIndex Extension Level that the base station is using is LEVEL256 in step 1016. If the MACIndex Extension Level that the base station is using is LEVEL256, the mobile station considers the Secondary Preamble is detected in step 1012. If the MACIndex Extension Level that the base station is using is not LEVEL256, the mobile station detects the Secondary Preamble on I-branch in step 1018 with a preamble length determined in step 1004. In step 1020, the mobile station determines whether both the Primary Preamble and the Secondary Preamble for MACIndex i are detected. If both preambles are detected, the mobile station tries to decode the Physical Layer packet in step 1030. If either of the two preambles is not detected, the mobile station determines whether it has tested all MACIndex values that it needs to test in step 1022. If not, the mobile station selects the next MACIndex i that needs to be tested in step 1024, then repeats the steps from step 1004 to step 1020. If the mobile station has tested all MACIndex values that its needs to test, the mobile station, in step 1026, determines whether the flag NACK4SlotAgo(k) is “0” or “1”, where k is the modulus or the remainder after division of the current time slot number by 4, meaning whether it had sent a NACK to the base station 4 time slots ago. If the flag NACK4SlotAgo(k) is “0” or the mobile station didn't send a NACK 4 time slots ago, the mobile station waits for the next time slot. If the flag NACK4SlotAgo(k) is “1” or the mobile station sent a NACK 4 time slots ago, the mobile station soft-combines the data packet in the current time slot with that received 4 slots ago in step 1028 and tries to decode it in step 1030. In step 1032, the mobile station determines whether the Physical Layer packet is decoded successfully. If the Physical Layer packet is decoded successfully, the mobile station sends an ACK signal on its Reverse ACK Channel in step 1034 then clears the flag NACK4SlotAgo(k) to “0” in step 1036. If the Physical Layer packet is not decoded successfully, the mobile station sends a NACK signal on its Reverse ACK Channel in step 1038. Then the mobile station determines whether the failed data packet has exhausted to its last scheduled slot in step 1040. If it is the last slot, the mobile station clears the flag NACK4SlotAgo(k) to “0” in step 1036. If it is not the last slot, the mobile station sets the flag NACK4SlotAgo(k) to “1” in step 1042.

Although, for illustration purpose, FIG. 10A shows the mobile station procedures for detecting the preambles from step 1002 to step 1022 in a serial fashion, i.e. one MACIndex after another, parallel detection with steps from step 1004 to step 1020 for each MACIndex value that the mobile station needs to detect is readily apparent to those skilled in the art and is also within the scope of the present invention.

FIG. 10B further illustrates the mobile station procedures for detecting the Primary Preamble in step 1014 in greater details, according to the second embodiment of the present invention. Referring to FIG. 10B, the mobile station despreads the Primary Preamble received on the Q-branch with the bi-orthogonal cover that is generated from the seven least significant bits B₆B₅B₄B₃B₂B₁B₀ of MACIndex i in step 1080 and estimates the despread signal power in step 1082. The mobile station further estimates the noise variance on the Q-branch in step 1084. Then the mobile station calculates the Primary Preamble Signal-to-Noise Ratio (SNR) by dividing the Primary Preamble signal power by the noise variance in step 1086. The mobile station further determines whether the Primary Preamble SNR is greater than the threshold in step 1088. If it is greater than the threshold, the mobile station concludes that the Primary Preamble is detected in step 1090. If it is less than the threshold, the mobile station concludes that the Primary Preamble is not detected in step 1092. The threshold may be a fixed value or it may be a function of the Primary Preamble Gain, which may be 1, PGAIN1, PGAIN2, PGAIN3, PGAIN4, PGAIN5, or PGAIN6 in the example described above, depending on the MACIndex i value under test and MACIndex Extension Level that the base station is using. The base station may compute and provide a set of thresholds for the mobile station to use in signaling messages, or the mobile station may compute the thresholds using the information of PGAIN1, PGAIN2, PGAIN3, PGAIN4, PGAIN5, or PGAIN6 that the base station provides in the signaling messages.

It is readily apparent to those skilled in the art that the same procedures illustrated in FIG. 10B can be used to further describe step 1010 in greater details, except that the Primary Preamble is received on I-branch, the mobile station estimates the noise variance on the I-branch, and the Primary Preamble Gain is always 1 in this case.

Table 6 below shows the Secondary Preamble hypotheses for each MACIndex Extension Levels according to the second embodiment of the present invention.

TABLE 6

| MACIndex | |
|---|---|
| Extension | |
| Level | Secondary Preamble Hypotheses |
| LEVEL256 | None |
| LEVEL384 | OFFSET_{Secondary} + 1 and OFFSET_{Secondary} + 2 |
| LEVEL512 | OFFSET_{Secondary} + 1, OFFSET_{Secondary} + 2, and |
| | OFFSET_{Secondary} + 3 |
| LEVEL640 | OFFSET_{Secondary} + 1, OFFSET_{Secondary} + 2, |
| | OFFSET_{Secondary} + 3, and OFFSET_{Secondary} + 4 |
| LEVEL768 | OFFSET_{Secondary} + 1, OFFSET_{Secondary} + 2, |
| | OFFSET_{Secondary} + 3, OFFSET_{Secondary} + 4, |
| | and OFFSET_{Secondary} + 5 |
| LEVEL896 | OFFSET_{Secondary} + 1, OFFSET_{Secondary} + 2, |
| | OFFSET_{Secondary} + 3, OFFSET_{Secondary} + 4, |
| | OFFSET_{Secondary} + 5, and OFFSET_{Secondary} + 6 |
| LEVEL1024 | OFFSET_{Secondary} + 1, OFFSET_{Secondary} + 2, |
| | OFFSET_{Secondary} + 3, OFFSET_{Secondary} + 4, |
| | OFFSET_{Secondary} + 5, OFFSET_{Secondary} + 6, |
| | and OFFSET_{Secondary} + 7 |

FIG. 11 illustrates the enhanced Multi-User MAC Layer Packet format that supports more than 256 MACIndex values, according to the present invention. Referring to FIG. 11, the enhanced Multi-User MAC Layer Packet consists of n PacketInfo 1102 fields and n Length 1104 fields, where 1≦n≦8, optional MACHeaderDelimiter 1106 field, MAC Layer Payload 1108 of n Security Layer packets, optional MAC Layer Pad 1110, m optional PacketInfo Trailers 1112, where m is the number of PacketInfo Trailer Indicators that is “1” in the MAC Layer Header and 0≦m≦8, and MAC Layer Trailer 1114. PacketInfo 1102 field consists of 1-bit PacketInfo Trailer Indicator (PTI) 1120 and the seven least significant bits B₆B₅B₄B₃B₂B₁B₀ of the MACIndex of the target mobile station. If the target mobile station to which the nth Security Layer packet in the MAC Layer Payload 1108 is addressed is a legacy mobile station, the base station sets the PacketInfo Trailer Indicator 1120 in the nth PacketInfo 1102 field to “0”, puts the seven least significant bits B₆B₅B₄B₃B₂B₁B₀ of the MACIndex of the target mobile station in the remaining seven bits 1122 in the nth PacketInfo 1102 field, and omits the PacketInfo Trailer 1132 that corresponds to the nth PacketInfo 1102 field. If the target mobile station to which the nth Security Layer packet in the MAC Layer Payload 1108 is addressed is not a legacy mobile station, the base station sets the PacketInfo Trailer Indicator 1120 in the nth PacketInfo 1102 field to “1”, puts the seven least significant bits B₆B₅B₄B₃B₂B₁B₀ of the MACIndex of the target mobile station in the remaining seven bits 1122 in the nth PacketInfo 1102 field, and puts the three most significant bits B₉B₈B₇ of the MACIndex of the target mobile station in the PacketInfo Trailer 1132 that corresponds to the nth PacketInfo 1102 field. For the mobile receiver, if the PacketInfo Trailer Indicator 1120 of the nth PacketInfo 1102 field is “0”, it indicates that the nth Security Layer packet in MAC Layer Payload 1108 is for a legacy mobile station with a MACIndex value that is indicated by the remaining seven bits 1122 in the PacketInfo 1102 field. If the PacketInfo Trailer Indicator 1120 of the nth PacketInfo 1102 field is “1”, it indicates that the nth Security Layer packet in MAC Layer Payload 1108 is for an enhanced mobile station with a MACIndex of 10 bits, of which the seven least significant bits B₆B₅B₄B₃B₂B₁B₀ are indicated by the remaining seven bits 1122 in the PacketInfo 1102 field and the three most significant bits B₉B₈B₇ are indicated by the three bits in the corresponding PacketInfo Trailer 1132. The PacketInfo Trailers, if transmitted, are transmitted in the reverse order comparing to the order of which the corresponding n PacketInfo fields are transmitted in the MAC Layer Header, for example if both included, PacketInfo Trailer 1130 corresponding to the first PacketInfo 1100 field is closer to MAC Trailer 1114 than PacketInfo Trailer 1132 corresponding to the nth PacketInfo 1102 field is, where n>1. The nth Length 1104 field indicates the length, in octets, of the nth Security Layer packet in MAC Layer Payload 1108. MACHeaderDelimiter 1106 field is included if at least one PacketInfo Trailer Indicators in the n PacketInfo fields is “1” or if all PacketInfo Trailer Indicators in the n PacketInfo fields are “0”s and the MAC Layer Packet size exceeds the sum of the length of the Security Layer Packets, MAC header, and MAC Trailer 1114 by one or more octets. If included, MACHeaderDelimite 1106 field is set to ‘0000000’. Pad 1110 bits are included if the size of the MAC Layer Packet exceeds the sum of the lengths of the n Security Layer packets, MAC header, MACHeaderDelimiter 1106 (if included), PacketInfo Trailers 1112 (if included), and MAC Trailer 1114. If included, Pad 1110 bits have a size that equals the size of the MAC Layer packet minus the size of MAC Layer header, MACHeaderDelimiter 1106 (if included), MAC Layer Payload 1108, PacketInfo Trailers 1112 (if included), and MAC Trailer 1114. If included, Pad 1110 bits are all “0”s.

Thus, novel and improved methods and apparatus for identifying target mobile stations with expanded MACIndex space have been described. Those skilled in the art may implement the described techniques in varying ways, for example, omitting certain logical levels, blocks or steps described and omitting the bit B₉ or B₈ or replacing it with “0” when the MACIndex representation is limited to 8 bits or 9 bits, or adding bits, logical levels, blocks and steps when the MACIndex representation is further expanded to 11 bits or more. Apparently, 8-bit representation of MACIndex is a special case where the Secondary Preamble is not used and only the First Preamble is transmitted on the in-phase branch or the quadrature branch of the radio frequency carrier. Those skilled in the art may also choose a different bit other than the bit B₇ to determine on which branch the Primary Preamble is transmitted. Such modifications should not be interpreted as causing a departure from the scope of the present invention.

The various illustrative logical blocks, modules, and circuits described in connection with the embodiment disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

The steps of a method or algorithm described in connection with the embodiments disclosed herein may be implemented or performed directly in hardware, in a software module executed by a processor, or in combination of the two. A software module may reside in RAM memory, flash memory, ROM memory, EPROM memory, EEPROM memory, registers, or any other form of storage medium in the art.

What is claimed is:

1. A method for transmitting data traffic in a wireless communication system, comprising:
generating a first preamble, wherein the first preamble carries the first portion of the target mobile station identity information;
generating a second preamble, wherein the second preamble carries the second portion of the target mobile station identity information;
applying the first preamble with the first transmit power on one branch of the In-phase and Quadrature signal while simultaneously applying the second preamble with the second transmit power on the other branch of the In-phase and Quadrature signal, wherein which branch the first preamble is on depends on the third portion of the target mobile station identity information; and
transmitting the In-phase and Quadrature signal of the first preamble and the second preamble before the data packet.

2. The method of claim 1, wherein the first portion of the target mobile station identity information is the n least significant bits of the number that represents the target mobile station identity in the system.

3. The method of claim 2, wherein the number n is seven.

4. The method of claim 1, further comprising:
selecting the MACIndex Extension Level based on the maximal number of MACIndex that can be represented in one sector in the network;
determining the second portion of the target mobile station identity information that is used to generate the second preamble according to the selected MACIndex Extension Level;
determining the first transmit power on the first preamble and the first transmit power on the second preamble according to the selected MACIndex Extension level; and
informing the mobile stations about the selected MACIndex Extension level by the base station.

5. The method of claim 4, in which:
the selected MACIndex Extension level corresponds to a maximal of 256 MACIndex;
the first preamble is transmitted with the total transmit power of the base station; and
the second transmit power is zero and the second preamble is not gated off.

6. The method of claim 5, wherein the first preamble is transmitted on the in-phase branch of the radio frequency carrier for a MACIndex that is less than 128 and on the quadrature branch of the radio frequency carrier for a MACIndex that is greater than 127.

7. The method of claim 4, in which:
the selected MACIndex Extension level corresponds to a maximal of 512 MACIndex;
the first preamble is transmitted with a power that is less than the total transmit power of the base station; and
the second preamble is transmitted with a power that is greater than zero but less than or equal to the first transmit power.

8. The method of claim 1, wherein the third portion of the target mobile station identity information is the k^{th} bit, starting from the least significant bit, of the number that represents the target mobile station identity in the system.

9. The method of claim 7, wherein the number k is eight.

10. A method for transmitting the identity of the target receiving mobile station in the preamble in a wireless communication system, comprising:
representing the identity of the target receiving mobile station with 8-bit MACIndex with a range of 0 to 255;
generating a bi-orthogonal sequence from the MACIndex of the target receiving mobile station;
covering an all “+1” sequence with the bi-orthogonal sequence;
repeating the covered sequence according to the preamble length; and
transmitting the repeated sequence on the in-phase branch of the radio frequency carrier for a MACIndex that is less than 128 and transmitting the repeated sequence on the quadrature branch of the radio frequency carrier for a MACIndex that is greater than 127.

11. The method of claim 9, wherein the repeated sequence is transmitted on the in-phase branch of the radio frequency carrier with full power while zero power is transmitted on the quadrature branch of the radio frequency carrier for a MACIndex that is less than 128 and the repeated sequence is transmitted on the quadrature branch of the radio frequency carrier with full power while zero power is transmitted on the in-phase branch of the radio frequency carrier for a MACIndex that is greater than 127.
